(19) United States
(12) Patent Application Publication
(10) Pub. No.: US 2019/0292064 A1
(43) Pub. Date: Sep. 26, 2019

(54) USE OF A UREA COMPOSITION TO PRODUCE DIESEL EXHAUST FLUID (AUS 32)

(71) Applicants: THYSSENKRUPP FERTILIZER TECHNOLOGY GMBH, Dortmund (DE); thyssenkrupp AG, Essen (DE)

(72) Inventors: Thomas KRAWCZYK, Wuppertal (DE); Matthias POTTHOFF, Dortmund (DE)

(73) Assignees: THYSSENKRUPP FERTILIZER TECHNOLOGY GMBH, Dortmund (DE); thyssenkrupp AG, Essen (DE)

(21) Appl. No.: 16/317,277

(22) PCT Filed: Jul. 13, 2017
(86) PCT No.: PCT/EP2017/067657

§ 371 Date: Jan. 11, 2019

(30) Foreign Application Priority Data
Jul. 15, 2016 (DE) 10 2016 213 012.9

(51) Int. Cl. C01C 1/08; B01D 53/94; B01D 53/86; F01N 3/20

(52) U.S. Cl. CPC C01C 1/086; B01D 53/9409; F01N 2610/02; F01N 3/2066; B01D 53/8625

(57) ABSTRACT

A process for producing a NOx reductant AUS 32 solution (diesel exhaust fluid), including at least the mixing of water and a particulate composition including (i) urea and an additive comprising component (ii). The additive component is a combination of at least one polymer or oligomer containing amino groups and at least one functionalized polyvinyl compound, wherein the proportion by weight of component (i) in the particulate composition is >60% by weight and the proportion by weight of component (ii) in the particulate composition is <1% by weight and wherein a urea solution is obtained and the proportion by weight of component (i) in the urea solution obtained is between 31% by weight and 34% by weight.

The invention relates to processes for producing a NOₓ reductant AUS 32 solution (diesel exhaust fluid) from a particulate, urea-containing composition, to the use thereof in diesel vehicles and to a NOₓ reductant AUS 32 solution (diesel exhaust fluid) obtainable via the process of the invention.

Various processes are known in the prior art for the production of particulate, urea-containing compositions. In the past, urea particles were typically produced by means of spray crystallization, by spraying an essentially anhydrous urea melt (water content of 0.1% to 0.3% by weight) from the upper portion of a spray crystallization tower into an ascending stream of air at ambient temperature and solidification of the droplets to give crystals (prills). The prills thus obtained have relatively small diameters and low mechanical strength.

Urea particles having greater particle diameters and better mechanical properties are nowadays usually produced by granulation of an essentially anhydrous urea melt or an aqueous urea solution in a fluidized bed as described, for example, in U.S. Pat. No. 4,219,589. In these granulation processes, an aqueous urea solution with a urea concentration of 70-99.9% by weight, in the form of very finely divided droplets having an average diameter of 20-120 μm, is introduced into a fluidized bed of urea particles, the temperature being chosen such that the water in the solution sprayed onto the urea particles evaporates and urea is deposited on the particles, giving a granular material having a desired particle size of 2.5 mm or more.

Since relatively large amounts of fine dust are obtained in this process, especially when the urea solution used has a water content of more than 5% by weight, granulation additives that reduce this formation of dust are frequently used. The effect of the addition of these additives is that the granule particles and especially the surface thereof remain plastic, such that round particles having a smooth surface and good mechanical stability are obtained owing to their rolling motions and collisions. The granular material thus obtained therefore has high compressive strength and shock resistance, a low tendency to form dust as a result of abrasion, and additionally only a low tendency to clumping even in the course of prolonged storage. However, corresponding granulation additives find use not just in fluidized bed granulation but also in other processes, for example spray crystallization or drum granulation.

Granulation additives used are typically formaldehyde or water-soluble addition and/or condensation products of formaldehyde and urea, but these have to be added in relatively large amounts and are not unproblematic in terms of handling owing to their toxic properties. Escapes of formaldehyde constitute an acute risk to health and the environment, even though the introduction of urea-formaldehyde prepolymers such as UF80 or UF85 has reduced such risks. Moreover, in accordance with the classification as a “carcinogenic substance” by the IARC (International Agency for Research on Cancer as part of WHO), the question of risks to health also arises in connection with chronic exposure to formaldehyde vapors, which cannot be entirely prevented even through the use of such prepolymers.

A further problem in the granulation of urea is the formation of dust, which is understood to mean particles having a diameter of less than 0.5 mm. The formation of dust is essentially attributable to three sources. Mention should be made firstly of the abrasion of the granular material owing to movements and collisions between the particles, for example in the fluidized bed, where the amount of dust obtained depends essentially on the mechanical properties of the granular material. In addition, the nozzles each generate droplets with a certain distribution of diameters, in which case the finest droplets solidify before they meet the urea particles, and so the dust thus formed leaves the granulator again with the waste air. Finally, the third source that should be mentioned is the dust obtained from the comminution of excessively large granule particles, which, in the processes and plants according to the prior art, is typically transferred directly back into the granulator. 10% to 20% by weight of the comminuted particles have a diameter of less than 1 mm, and a high proportion thereof is dust. Thus, 1% to 1.5% dust per tonne of the end product is returned back to the granulator via this proportion of comminuted particles, and 3-5% of the total dust per tonne of the end product from an industrial plant is attributable to the granulator.

For avoidance or reduction of the aforementioned disadvantages, different alternatives to formaldehyde and the water-soluble addition and/or condensation products thereof have been examined, but each is also afflicted by restrictions or disadvantages.

Reference is made by way of example to the use of alkali metal lignosulfonates as described in U.S. Pat. No. 5,766,302, or to the use of glyoxal or carbohydrates. However, in the urea product obtained, depending on the production process, these lead to a yellowish or brownish color which is undesirable in many cases, for example in the production of melamine. On the other hand, the use of surface-active substances, for example mixtures of polyvinyl acetate and polyvinyl alcohol, as granulation additives, likewise leads to problems since these have a tendency to foam, for example when the additive is mixed with the melt or in the washers where the treated urea dust is dissolved and the efficiency of the washers is impaired. The tendency of these substances to form foam also has effects on the end product, which has a lower density and is not accepted by the market. Overall, therefore, a tendency to foam formation on industrial use of the urea granules is unacceptable.

In view of ever stricter environmental regulations relating to the emission of nitrogen oxides (NOx) from diesel vehicles, the use of urea solutions of technical grade purity is becoming ever more significant. The urea solution here is introduced into the exhaust gas and leads, in a selective catalytic reduction (SCR), to conversion of the nitrogen oxides present in the exhaust gas to nitrogen (N₂) and water (H₂O). The urea injected into the exhaust gas is broken down thermally to ammonia (NH₃). The ammonia thus released reduces the nitrogen oxides present in the exhaust gas. The composition of this urea solution of technical grade purity, also known as diesel exhaust fluid, AUS 32 (aqueous urea solution) or AdBlue®, is fixed very accurately according to ISO 22241. The urea solution of technical rate purity contains 32.5% by weight of urea. A list of the quality features and impurities can also be found in DIN 7007:2005-08. This standard fixes a limit of 5 mg/kg for aldehydes in particular.

Owing to the strict regulations relating to the purity of urea, it is not possible to use any desired urea sources. In general, therefore, the urea obtained directly in preparation is admixed with demineralized water (distilled water) in the defined concentration and transported to the site of use. In this manner, as well as the urea, up to ⅔ water is transported as well. Moreover, these aqueous solutions cannot be transported and stored for as long as desired; instead, biological breakdown is possible. The alternative, i.e. the transport of granular urea to the site of use, often fails because of the aldehydes present in the granular material, which prevent use as NOx reductant AUS 32 solution.

It is therefore an object of the present invention to provide a process for producing a NOx reductant AUS 32 solution (diesel exhaust fluid) from a particulate urea-containing compositions and water which has the disadvantages of the prior art at least in reduced form, if at all.

This object is achieved by the subject matter of the description and the claims.

It has been found that, surprisingly, by the process of the invention, by mixing of water with a urea-containing, particulate composition having satisfactory properties without the use of formaldehyde and urea-formaldehyde condensates can be obtained and can be used together with demineralized water for production of an NOₓ reductant AUS 32 solution (diesel exhaust fluid), preferably according to ISO 22241. In this way, more particularly,
it is possible to provide urea-containing particles which meet the purity specifications for the production of an AUS 32 solution (diesel exhaust fluid). Furthermore, the production of the AUS 32 solution (diesel exhaust fluid) can be decentralized from the urea synthesis and hence the amount to be transported can be reduced by up to ⅔. This not only lowers the necessary fuel consumption but also the emissions released in the course of transport. Moreover, there is a distinct reduction in the cost and inconvenience involved in the packaging of the NOₓ reductant AUS 32 solution. The cost and inconvenience involved in transport and packaging of a NOₓ reductant AUS 32 solution which is heavier by up to ⅔ at the site of urea synthesis to the site of use is much higher than for the packaging and transport of a smaller amount of granular urea.
it is possible to avoid the risks to health and the environment that are associated with the use of formaldehyde and urea-formaldehyde condensates; and/or
it is possible to provide a less costly alternative for the production of the compositions compared to compositions produced using formaldehyde and urea-formaldehyde condensates. The urea composition of the invention allows the use of granular urea optimized for the fertilizer sector. The inventive urea composition in aqueous solution surprisingly fulfills the limits specified in standard DIN 70070:2005-08 in table 1 for AUS 32 solution (diesel exhaust fluid). By contrast, conventional urea compositions for the fertilizer sector generally can not comply with this standard particularly because of the high formaldehyde content; and/or
it is possible to reduce or even completely avoid the formation of dust during the production of the composition, and/or
it is possible to obtain a particulate composition, the particles of which, by comparison with compositions produced using formaldehyde and urea-formaldehyde condensates, exhibit at least comparable or even better properties, especially with regard to mechanical properties, for example compressive strength, shock resistance, low tendency to abrasion or to clumping, especially in the course of prolonged storage.

The invention relates to a process for producing a NOₓ reductant AUS 32 solution (diesel exhaust fluid), comprising at least the mixing of water and a particulate composition comprising:

(i) urea;

and an additive comprising a component (ii):

(ii) combination of at least one polymer or oligomer containing amino groups and at least one functionalized polyvinyl compound;

wherein the proportion by weight of component (i) in the particulate composition is >60% by weight and the proportion by weight of component (ii) in the particulate composition is <1% by weight and

wherein a urea solution is obtained and the proportion by weight of component (i) in the urea solution obtained is between 30% by weight and 35% by weight (inclusive), especially 31% by weight and 34% by weight, especially 31.8% by weight and 33.2% by weight. The urea solution obtained, within the scope of the concentrations specified in ISO 22241, corresponds to the NOₓ reductant AUS 32 solution (diesel exhaust fluid).

The particulate composition of the invention preferably contains only small amounts, if any, of aldehydes and/or sulfur of less than 20 ppm. In the context of the invention, this means that the mentioned components in the obtainable NOₓ reductant AUS 32 solution are present in lower concentration than specified under ISO 22241 and/or DIN 70070:2005-08.

Polymers and oligomers containing amino groups that are used in accordance with the invention especially include polymers and oligomers having a molecular weight (MW) of 250 to 2 000 000, of 300 to 2 000 000, of 350 to 2 000 000, of 400 to 2 000 000, of 450 to 2 000 000, of 500 to 2 000 000, of 550 to 2 000 000, of 600 to 2 000 000, of 650 to 2 000 000, of 700 to 2 000 000, of 750 to 2 000 000, of 800 to 2 000 000, of 850 to 2 000 000, of 900 to 2 000 000, of 950 to 2 000 000, of 1000 to 2 000 000, of 1050 to 2 000 000, of 1100 to 2 000 000, of 1150 to 2 000 000, and of 1200 to 2 000 000 daltons.

For example, the polymers and oligomers containing amino groups that are used in accordance with the invention may have a molecular weight (MW) of 500 to 1 000 000, of 550 to 1 000 000, of 600 to 1 000 000, of 650 to 1 000 000, of 700 to 1 000 000, of 750 to 1 000 000, of 800 to 1 000 000, of 850 to 1 000 000, of 900 to 1 000 000, of 950 to 1 000 000, of 1000 to 1 000 000, of 1050 to 1 000 000, of 1100 to 1 000 000, of 1150 to 1 000 000, and of 1200 to 1 000 000 daltons, or in the range from 500 to 10 000, from 550 to 10 000, from 600 to 10 000, from 650 to 10 000, from 700 to 10 000, from 750 to 10 000, from 800 to 10 000, from 850 to 10 000, from 900 to 10 000, from 950 to 10 000, from 1000 to 10 000, from 1050 to 10 000, from 1100 to 10 000, from 1150 to 10 000, and from 1200 to 10 000 daltons.

Preferably, the polymers and oligomers containing amino groups may have a nitrogen content of 10% to 50% by weight, based on the weight of the polymer or oligomer, and contain primary, secondary or tertiary amino groups that independently contain alkyl or arylalkyl groups, for example C₁₋₆-alkyl or aryl-C₁₋₃-alkyl where aryl may especially be phenyl or pyridyl which may be unsubstituted or optionally substituted by 1, 2, 3, 4 or 5 substituents independently selected from the group consisting of F, Cl, Br, CF₃, C₁₋₆-alkyl, C₁₋₆-alkoxy, NH₂, C₁₋₆-alkylamino and di(C₁₋₆-alkyl)amino.

For example, useful polymers and oligomers containing amino groups include polyamines, polymeric polyamines, nitrogen-substituted vinyl polymers, polyoxazolines, polypropyleneimine and dendrimers thereof, polyethyleneimine and dendrimers thereof, polyamidoamine and dendrimers thereof, and copolymers and derivatives and combinations of two or more of the substances mentioned.

Preferred polymers and oligomers containing amino groups include polyamines and polymeric polyamines, polyalkyleneimines, for example polyethyleneimines and polypropyleneimines, polyvinylamines, polyalkoxylated polyamines, ethoxylated polyamines, propoxylated polyamines, alkylated and benzylated polyamines, and combinations of two or more of the aforementioned components.

Polymers and oligomers containing amino groups that are used with particular preference are polyethyleneimines, polyethyleneimine dendrimers, and their copolymers, derivatives and mixtures of at least two of these components.

Suitable polyethyleneimines may include linear or branched polyethyleneimine polymers or oligomers having, for example, 10 or more monomer units and their derivatives, analogs, copolymers and mixtures of at least two of these components.

Polyethyleneimines can be obtained by the polymerization of ethylene imine and are commercially available on the market, for example in the form of the Lupasol® and Epomin® product families and here especially the Lupasol® G20, Lupasol® FG, Lupasol® G35, Lupasol® P, and Lupasol® 1595 products (the Lupasol® products are available from BASF (Florham Park, N.J., USA)), and also Epomin® SP-003, Epomin® SP-006, Epomin® SP-012, Epomin® SP-018, Epomin® SP-200, Epomin® SP-1000, and Epomin® SP-1050 (the Epomin® products are available from Nippon Shokubai (Osaka, Japan)).

According to the invention, useful functionalized polyvinyl compounds especially include compounds based on the repeat (CHXCHY)ₙ unit in which X is selected from the group consisting of H, NH₂, OH, COOH, COR, CONH₂, CH₂NH₂, CH₂NHR, CH₂OH and CH₂OR and Y is selected from the group consisting of NH₂, OH, COOH, COR, CONH₂, CH₂NH₂, CH₂NHR, CH₂OH and CH₂OR and where R is in each case independently alkyl, especially C₁₋₆-alkyl, or aryl, especially phenyl or pyridyl, which may be unsubstituted or optionally substituted by 1, 2, 3, 4 or 5 substituents independently selected from the group consisting of F, Cl, Br, CF₃, C₁₋₆-alkyl, C₁₋₆-alkoxy, NH₂, C₁₋₆-alkylamino and di(C₁₋₆-alkyl)amino.

For example, the functionalized polyvinyl compounds used in accordance with the invention may have a molecular weight (MW) of 250 to 2 000 000, of 300 to 2 000 000, of 350 to 2 000 000, of 400 to 2 000 000, of 450 to 2 000 000, of 500 to 2 000 000, of 550 to 2 000 000, of 600 to 2 000 000, of 650 to 2 000 000, of 700 to 2 000 000, of 750 to 2 000 000, of 800 to 2 000 000, of 850 to 2 000 000, of 900 to 2 000 000, of 950 to 2 000 000, of 1000 to 2 000 000, of 1050 to 2 000 000, of 1100 to 2 000 000, of 1150 to 2 000 000, and of 1200 to 2 000 000 daltons.

Useful functionalized polyvinyl compounds preferably include polyvinyl alcohol or polyvinylamine or the mixture thereof. The functionalized polyvinyl compound is more preferably a polyvinylamine.

The polyvinylamine and the polyvinyl alcohol may each preferably have a molecular weight (MW) of 500 to 1 000 000, of 550 to 1 000 000, of 600 to 1 000 000, of 650 to 1 000 000, of 700 to 1 000 000, of 750 to 1 000 000, of 800 to 1 000 000, of 850 to 1 000 000, of 900 to 1 000 000, of 950 to 1 000 000, of 1000 to 1 000 000, of 1050 to 1 000 000, of 1100 to 1 000 000, of 1150 to 1 000 000, and of 1200 to 1 000 000 daltons or in the range from 500 to 10 000, from 550 to 10 000, from 600 to 10 000, from 650 to 10 000, from 700 to 10 000, from 750 to 10 000, from 800 to 10 000, from 850 to 10 000, from 900 to 10 000, from 950 to 10 000, from 1000 to 10 000, from 1050 to 10 000, from 1100 to 10 000, from 1150 to 10 000, and from 1200 to 10 000 daltons.

Suitable polyvinylamines especially include linear polymers and copolymers that derive from vinylformamide monomers and may include cationic and anionic polyvinylamine copolymers and charged and protonated polyvinylamines.

Suitable polyvinylamines are commercially available on the market, for example those from the Lupamin® product family and here especially the Lupamin® 1595, Lupamin® 4500, Lupamin® 5095, Lupamin® 9030, Lupamin® 9050 and Lupamin® 9095 products. Examples of cationic and anionic polyvinylamine copolymers are those from the Luredur® product family and here especially the Luredur® Am na, Luredur® AV, Luredur® VH, Luredur® VI, Luredur® VM, Luredur® PR8094, Luredur® PR8261, and Luredur® PR8349 products. Examples of charged or protonated polyvinylamines are products from the Catiofast® product series and here especially the products Catiofast® GM, Catiofast® PL, Catiofast® PR8236, Catiofast® VCB, Catiofast® VFH, Catiofast® VLW, Catiofast® VMP and Catiofast® VSH. The Lupamin®, Luredur®, and Catiofast® products are available from BASF (Florham Park, N.J., USA).

Unless stated otherwise, the weight figures (% by weight) given in connection with the particulate composition always relate in each case to the total weight of the particulate composition. The person skilled in the art will recognize that the components and weight figures given need not be satisfied for any arbitrarily small portion of the particles, but rather on average across a representative amount of the particles produced.

Unless stated otherwise, the weight figures (% by weight) given in connection with the NOₓ reductant AUS 32 solution or urea solution always relate in each case to the total weight of the NOₓ reductant AUS 32 solution or urea solution.

The particulate composition of the invention may optionally contain further constituents as well as the constituents mentioned. The nature of the constituents and the amount thereof depend, for example, on the component (i) used. For instance, the particulate composition of the invention may contain water, for example in an amount of 0.05% to 0.5% by weight, especially 0.1% to 0.3% by weight, and by-products from the urea synthesis, for example biuret or NH₃. Typically, the proportion of the by-products is not more than 1.5% by weight, especially not more than 1.25% by weight.

In a preferred embodiment of the process, the particulate composition comprises, as component (iii) of the additive, at least one compound selected from the group consisting of the aliphatic dicarboxylic acids, their salts and anhydrides, the aliphatic tricarboxylic acids, their anhydrides, the aromatic dicarboxylic acids, their salts and anhydrides, and the anhydrides, where, preferably, the proportion by weight of component (i) is >60% by weight and the proportion by weight of the sum total of components (ii) and (iii) in the composition is <1% by weight.

It will be apparent to this person skilled in the art that the components (ii) and (iii) used in the production of the particulate composition may possibly interact partly or fully with one another and possibly also with the urea component (i). For example, crosslinking to form covalent bonds is known for aldehydes or carboxylic anhydrides with urea, or the formation of complexes of urea and carboxylic acids. Components such as polyvinyl alcohol and polyvinylamine for example tend to form hydrogen bonds. It may be the case that the components used for production of the particulate composition are therefore in partly or fully modified form in the end product obtained. The invention also encompasses such modified components.

In a particularly preferred embodiment of the process, the particulate composition of the invention comprises
(i) urea;

and an additive comprising component (ii) and a component (iii):
(ii) combination of polyethyleneimine and polyvinyl alcohol or combination of polyethyleneimine and polyvinylamine;
(iii) at least one compound selected from the group of the aliphatic dicarboxylic acids, salts and anhydrides thereof, the aliphatic tricarboxylic acids, salts and anhydrides thereof, the aromatic dicarboxylic acids, and anhydrides;

wherein preferably the proportion by weight of component (i) in the particulate composition is >97% by weight and the proportion by weight of the sum total of components (ii) and (iii) in the particulate composition is <1% by weight.

If the composition of the invention includes an aliphatic dicarboxylic acid as component (iii), it may preferably be selected from the group consisting of oxalic acid, malonic acid, succinic acid, glutaric acid, adipic acid, pimelic acid, suberic acid, azelaic acid, sebacic acid, undecanedioic acid, dodecanedioic acid, tridecanedioic acid, tetradecanedioic acid, hexadecanedioic acid, and the anhydrides of each. More preferably, the dicarboxylic acid of component (iii) present is oxalic acid, succinic acid or a mixture of these two acids.

If the composition of the invention includes an aliphatic tricarboxylic acid as component (iii), it may preferably be selected from the group consisting of citric acid, isocitric acid, and the anhydrides of each. The tricarboxylic acid of component (iii) present is more preferably citric acid.

If the composition of the invention includes, as component (iii), an aromatic dicarboxylic acid or the anhydride thereof, it may preferably be selected from the group consisting phthalic acid, phthalic anhydride, isophthalic acid and terephthalic acid. The aromatic dicarboxylic acid of component (iii) or anhydride thereof which is present is more preferably phthalic acid, phthalic anhydride or a mixture thereof.

In a further preferred embodiment of the process, the particulate composition comprises
(i) urea;

and an additive comprising component (ii) and component (iii):
(ii) combination of polyethyleneimine and polyvinylamine;
(iii) at least one compound selected from the group consisting of oxalic acid, succinic acid, citric acid, phthalic acid and phthalic anhydride, where the proportion by weight of component (i) in the particulate composition is >97% by weight and the proportion by weight of the sum total of components (ii) and (iii) in the particulate composition is <1% by weight.

Very particularly preferred embodiments of the particulate composition in the process comprise
(i) urea;

and an additive selected from group (a)-(g)
(a) additive comprising (ii) a combination of polyethyleneimine and polyvinylamine;
(c) additive comprising (ii) a combination of polyethyleneimine and polyvinylamine and (iii) oxalic acid;
(d) additive comprising (ii) a combination of polyethyleneimine and polyvinylamine and (iii) citric acid;
(e) additive comprising (ii) a combination of polyethyleneimine and polyvinylamine and (iii) succinic acid;
(f) additive comprising (ii) a combination of polyethyleneimine and polyvinylamine and (iii) phthalic acid;
(g) additive comprising (ii) a combination of polyethyleneimine and polyvinylamine and (iii) phthalic anhydride;

where the proportion by weight of component (i) in the particulate composition is >97% by weight and the proportion by weight of the sum total of components (ii) and (iii) in the particulate composition is <1% by weight.

The proportion by weight of component (i) in the particulate composition is preferably >97% by weight, more preferably >98% by weight, most preferably >98.5% by weight.

The proportion by weight of the additive component can vary, for example depending on the components (ii) and (iii) used. Preferably, the proportion by weight of the sum total of components (ii) and (iii) in the particulate composition is <0.5% by weight, more preferably <0.4% by weight, even more preferably <0.3% by weight and even further preferably <0.25% by weight.

If the additive component includes two or more components, the relative proportions thereof may also vary. For example, the weight ratio of components of components (ii) and (iii) may be in the range from 1:20 to 20:1, preferably from 1:15 to 15:1, more preferably 1:10 to 10:1 and encompass incremental values in between.

Very particularly preferred embodiments of the particulate composition of the process comprise a combination of polyethyleneimine and polyvinylamine. The weight ratio of polyethyleneimine and polyvinylamine within the combination of these two components may vary, for example within the range from 1:20 to 20:1, preferably from 1:15 to 15:1, more preferably 1:10 to 10:1, and encompass incremental values in between.

In addition, the weight ratio of the combination of the two components polyethyleneimine and polyvinylamine to component (iii) may also vary and may in each case, for example, be within the range from 1:20 to 20:1, preferably from 1:15 to 15:1, more preferably 1:10 to 10:1, and encompass incremental values in between.

In a preferred embodiment of the process, the particulate composition of the invention is essentially free of formaldehyde. The expression “essentially free of formaldehyde” in the context of the present invention means that the composition includes <0.1% by weight, preferably <0.05% by weight, more preferably <0.005% by weight and even further preferably <0.0005% by weight of formaldehyde.

The invention further encompasses a NOₓ reductant AUS 32 solution (diesel exhaust fluid) obtainable by the process of the invention. This NOₓ reductant AUS 32 solution differs in its impurities that are defined by the particle additives from pure urea-in-water solutions. Particularly polymeric additions are difficult to characterize in any other way except via the process.

All preferred embodiments that have been described above in connection with the particulate composition of the invention are also correspondingly applicable to the inventive use of the additive for production of a particulate composition comprising urea, and will therefore not be repeated at this point.

For reasons of completeness, disclosed hereinafter is another possible process according to WO 2015/193377 A1 for production of a particulate composition comprising urea, comprising the steps of:
(A) providing a urea-containing solution;
(B) granulating the urea-containing solution with addition of an additive having a composition as described above.

All preferred embodiments that have been described above in connection with the particulate composition of the invention are also correspondingly applicable to the disclosed process for producing a particulate composition comprising urea, and will therefore not be repeated at this point.

In a preferred embodiment of the process for producing a particulate composition, the urea content of the solution used in step (A) is >60% by weight, preferably >95% by weight, more preferably >97% by weight, even more preferably >98% by weight, even further preferably >98.5% by weight.

The granulating of the urea-containing solution with addition of an additive in step (B) can be effected by customary methods known to those skilled in the art, for example by means of spray crystallization (prilling), drum granulation or fluidized bed granulation.

In a disclosed embodiment of the process for producing a particulate composition, the granulation is effected in step (B) by means of fluidized bed granulation, comprising the steps of
(B1) providing urea-containing seeds;
(B2) fluidizing the urea-containing seeds;
(B3) spray application of the urea-containing solution using an additive having a composition as described above.

If the additive comprises two or more components, these can each be used individually or together, or else in the form of premixtures, in the process of the invention. The junctures and addition of the components may vary. For example, it is possible to add one or more of the components to the urea solution provided or else to add one or more of the components to the urea-containing solution only directly prior to the spray application thereof. Depending on the characteristics of the components, it may be advantageous to use the components in the form of solutions, suspensions, emulsions or the like. Suitable liquids for the solutions or other formulations especially include water, but also organic solvents, for example alcohols, ethers, etc.

The temperature of the urea-containing solution is preferably >130° C.

In one embodiment for production of a particulate composition, the process comprises step (C):
(C): separating the particulate urea composition, after production thereof, into three fractions, where

one fraction (F1) contains particles having the desired target size,

one fraction (F2) contains particles having a size above the desired target size, and

one fraction (F3) contains particles having a size below the desired target size, and

where, preferably, fraction F2 is recycled back into the process after a comminution of the particles and fraction F3 is recycled back into the process.

In plants for production of urea and further processing thereof to give particulate compositions, ammonia is typically also obtained. This can be converted by a scrubbing operation with suitable acids, for example nitric acid or sulfuric acid, to the corresponding ammonium salts, for example ammonium nitrate or ammonium sulfate, and these can be sent to a further use, for example in fertilizers. Suitable processes and procedure for the acid scrubbing are described, for example, in WO2010/060535.

In a further embodiment for production of a particulate composition, the process disclosed comprises step (D):
(D) acid scrubbing.

The acid scrubbing can advantageously also be effected using the above-described acids of component (iii).

A further disclosed aspect of the invention relates to an apparatus for production of a particulate composition comprising urea, comprising:
(a) a granulator;
(b) at least one means for the addition of an additive as described above;
(c) at least one means for the separation of the particulate composition into fractions of different particle size;
(d) optionally at least one means for the performance of an acid scrubbing.

In a preferred embodiment of the apparatus of the invention, the granulator (a) is a fluidized bed granulator.

The apparatus disclosed is particularly suitable for performance of the process disclosed.

A further aspect of the invention relates to the use of the AUS 32 solution of urea in water which is obtained in accordance with the invention in diesel vehicles, furnaces, trash incinerators, gas turbines, ships' engines or industrial plants for reduction of nitrogen oxides. For this purpose, the solution of the invention is injected, for example, into the exhaust gas stream from the vehicle and the nitrogen oxides are reduced to N₂ and H₂O over an SCR catalyst, for example composed of titanium. The mechanism proceeds, for example, via the thermolysis of the urea to isocyanic acid and subsequent hydrolysis to ammonia. The ammonia ultimately reacts over the catalyst with the nitrogen oxides.

There follows an elucidation of the invention by examples. These elucidations are merely illustrative and do not restrict the general scope of the invention.

### EXAMPLES

### Example 1

In a test plant, urea was granulated in a fluidized bed granulator having a cylindrical fluidized bed of diameter 40 cm at a temperature of about 108° C. The fluidized bed was concluded at its lower end by a perforated plate, the holes of which had a diameter of 2.0 mm. The fluidization air flowed at a superficial flow rate of about 2 m/s into the fluidized bed. An overflow was mounted 10 cm above the baseplate at the side wall of the bed. A defined amount (about 45 kg) of urea particles or urea granules having a narrow size distribution was then introduced into the granulator column as seeds for the granulation. The bed with the seeds (about 50 cm deep) was fluidized with hot air at a temperature of about 100° C., and the addition of 96 to 97% by weight urea solution at a temperature of about 135° C. was commenced as soon as the bed had reached the temperature of about 108° C. that was envisaged for the run. From a reservoir tank, the urea solution having a water content of 3-4% by weight was then introduced into the fluidized bed granulator at a rate of 350 kg/h via a spray nozzle that was operated at a temperature of about 140° C. with air, supplied at a rate of 240 kg/h. The additives used according to table 1 below for the granulation were then mixed with the urea solution at about 135°. Solids were discharged from the fluidized bed via an outlet at regular intervals of 5 minutes in order to achieve a largely constant height of the bed. The samples of the solids thus removed were then each sieved in order to determine the size distribution thereof. No solids were recycled into the fluidized bed granulator. The duration per batch was about 30 minutes in each case. After this time had elapsed, the feed was stopped, the granular material was cooled down to about 100° C. and removed from the fluidized bed granulator, and it was separated by sieving it into the different fractions. The fraction having the desired size distribution was then cooled down to about 60° C. in order to analyze the product properties thereof. All fractions were weighed in order to ascertain the growth rate of the granular material. In addition, the dust from the bag filters of the waste air apparatus was also collected and weighed.

In accordance with the procedure described above, comparative tests for granulation were also conducted without addition of additive and with polyvinylamine (PVA), a polyvinylamine/polyethyleneimine mixture or a standard additive (urea-formaldehyde additive UF80), and the granular material obtained in each case was correspondingly worked up and analyzed.

Table 1a below shows the corresponding assessment of the granular materials with regard to dust formation, compressive strength, density and clumping. The sensitivity to dust formation which is likewise stated is the result of a visual assessment of collected dust from a small fluidized bed cooler. The scale used for the assessment of the granular materials obtained is shown in table 1 b.

TABLE 1a

| | | | | | PEI/PVA/oxalic |
|---|---|---|---|---|---|
| | | | | PEI/PVA | acid |
| | | | | 95/5% by | 5/90/5% |
| Additive | — | UF80 | PVA | weight¹⁾ | by wt.²⁾ |
| Inventive (I)/ | C | C | C | I | I |
| comparative (C) | | | | | |
| Dosage | 0 | 5500 | 500 | 800 | 500 |
| mg/kg | | | | | |
| Parameters | | | | | |
| Dust in the | 5 | 2 | 5 | 3 | 2 |
| granulator filter | | | | | |
| Dust formation on | 5 | 2 | 4 | 2 | 3 |
| cooling | | | | | |
| Clumping % | 2 | 1 | 3 | 1 | 2 |
| Clump hardness | 3 | 1 | 3 | 1 | 1 |
| Compressive | 4 | 2 | 3 | 3 | 2 |
| strength | | | | | |
| Bulk density (loose) | 3 | 1 | 3 | 1 | 1 |
| Assessment | 22 | 9 | 21 | 11 | 11 |
| (not weighted) | | | | | |

PVA: polyvinylamine
PEI: polyethyleneimine
¹⁾based in each case on the mixture of PVA and PEI
²⁾based in each case on the mixture of PVA, PEI and oxalic acid

TABLE 1b

| | | | Compressive | | | |
|---|---|---|---|---|---|---|
| | Dust in the | Dust on | strength | Bulk density | Clumping | Hardness |
| _Scale | filter (%) | cooling | kg | (g/l) | (%) | (kg) |
| 1 | 0-4 | 0 | >3.5 | >675 | 0 | zero |
| 2 | >4-6 | 1 | >3.0-3.5 | 675-665 | 0-10 | low |
| 3 | >6-8 | 2 | >2.5-3.0 | <665-655 | 11-20 | moderate |
| 4 | >8-10 | 2-3 | >2.0-2.5 | <655-645 | 21-30 | hard |
| 5 | >10 | 3 | <2.0 | <645 | >30 | |

### Example 2

In accordance with the procedure described in example 1, the effect of an inventive granulation additive composed of oxalic acid in various dosages and of a mixture of 500 mg/kg of polyethyleneimine and polyvinylamine (40% by weight/60% by weight, based in each case on the mixture of polyethyleneimine and polyvinylamine) was determined. This was done by introducing the oxalic acid into the reservoir tank for the urea solution and feeding the polyethyleneimine/polyvinylamine mixture into the urea stream fed to the nozzle prior to spraying. The urea solution thus obtained, with a water content of 3% by weight, was then supplied at a temperature of 132° C. at a rate of 350 kg/h, and the workup was effected as described in example 1. A corresponding comparative test with formaldehyde was likewise conducted.

Table 2 below shows the respective proportion of dust in the fluidized bed granulator:

TABLE 2

| | Inventive (I)/ | Dosage | Dust content/ |
|---|---|---|---|
| | comparative (C) | in mg/kg | granulator in % |
| Oxalic acid | I | 0 | 5.19 |
| | I | 250 | 4.44 |
| | I | 500 | 4.05 |
| | I | 1000 | 2.81 |
| Formaldehyde | C | 4500 | 3.9 |

The studies of the granular materials obtained according to examples 1-2 showed that both dust formation and the properties of the granular material (compressive strength, tendency to clumping) improved on addition of the additives of the invention. The result was comparable with or even better than the results obtained when formaldehyde was used, and significantly smaller amounts of additive were required.

### Example 3

Example 3 shows, in table 3, a comparison between a comparative urea solution with typical fertilizer grade urea, i.e. typical urea used as fertilizer, and a urea solution of the invention.

TABLE 3

| | Specification | | Comparative | | |
|---|---|---|---|---|---|
| | AUS32 from DIN | | urea solution | Urea | |
| | 70070:2005-08, | | with typical | solution | |
| | Table 1 | | fertilizer grade | of the | |
| | Min. | Max. | urea | invention | |
| Urea content | 31.8 | 33.2 | 32.5 | 32.5 | % by wt. |
| Density at 20° C. | 1.087 | 1.093 | n.s. | 1.0903 | g/cm³ |
| Refraction at 20° C. | 1.3814 | 1.3843 | n.s. | 1.3828 | |
| Alkalinity as NH₃ | | 0.2 | n.s. | 0.2 | % |
| Biuret | | 0.3 | 0.276-0.333 | <0.3 | % |
| Aldehydes | | 5 | 1138-1788 | <5 | mg/kg |
| Insoluble constituents | | 20 | n.s. | <20 | mg/kg |
| Phosphates (PO₄) | | 0.5 | n.s. | <0.5 | mg/kg |
| Ca, Fe (each) | | 0.5 | n.s. | <0.5 | mg/kg |
| Cu, Zn, Cr, Ni, Al (each) | | 0.2 | n.s. | <0.2 | mg/kg |
| Mg, Na, K (each) | | 0.5 | n.s. | <0.5 | mg/kg |

As can be seen in table 3, the urea solution of the invention with 32.5% by weight of urea satisfies the limits given in the specification (table 1 of DIN 70070:2005-08). In the case of a typical commercial urea solution (fertilizer grade urea), likewise with 32.5% by weight of urea, the values for aldehydes are well above the limits. The content of biuret is in the region of the limit. The other proportions in the typical commercial urea solution (fertilizer grade urea) are not stated (n.s.).

Owing to the known very high aldehyde content of the comparable typical commercial urea solution, the possible use of the particulate urea composition of the invention, which has likewise been developed for the fertilizer sector, in the field of the AUS 32 solution (diesel exhaust fluid) is surprising. Same time, the particulate composition of the invention can be better dry and transported by comparison with urea of technical grade purity. The particulate composition of the invention shows higher particle stability, storability (higher tendency to caking in the technical grade urea), lower dust formation and lower water absorption than straight technical grade urea. These aforementioned disadvantages make it difficult to reproducibly make up an AUS 32 solution (diesel exhaust fluid) from technical grade urea.

1.-10. (canceled)

11. A process for producing a NOₓ reductant AUS 32 solution (diesel exhaust fluid), comprising at least the mixing of water and a particulate composition comprising:
(i) urea;
and an additive comprising component (ii):
(ii) a combination of at least one polymer or oligomer containing amino groups and at least one functionalized polyvinyl compound;
wherein the proportion by weight of component (i) in the particulate composition is >60% by weight and the proportion by weight of component (ii) in the particulate composition is <1% by weight, and
wherein a urea solution is obtained and the proportion by weight of component (i) in the urea solution obtained is not less than 31% by weight and not more than 34% by weight.

12. The process of claim 11, wherein the additive comprises component (iii):
(iii) at least one compound selected from the group of the aliphatic dicarboxylic acids, and anhydrides, the aliphatic tricarboxylic acids, and anhydrides, the aromatic dicarboxylic acids, and anhydrides,
wherein the proportion by weight of component (i) in the particulate composition is >60% by weight and the proportion by weight of the sum total of components (ii) and (iii) in the particulate composition is <1% by weight.

13. The process of claim 11, wherein the particulate composition comprises:
(i) urea;
and an additive comprising component (ii) and component (iii):
(ii) a combination of polyethyleneimine and polyvinyl alcohol or a combination of polyethyleneimine and polyvinylamine;
(iii) at least one compound selected from the group of the aliphatic dicarboxylic acids, and anhydrides, the aliphatic tricarboxylic acids, and anhydrides, the aromatic dicarboxylic acids, and anhydrides;
wherein the proportion by weight of component (i) in the particulate composition is >97% by weight and the proportion by weight of the sum total of components (ii) and (iii) in the particulate composition is <1% by weight.

14. The process of claim 11, wherein the particulate composition comprises:
(i) urea;
and an additive comprising component (ii) and component (iii):
(ii) a combination of polyethyleneimine and polyvinylamine;
(iii) at least one compound selected from the group consisting of oxalic acid, succinic acid, citric acid, phthalic acid, phthalic anhydride,
wherein the proportion by weight of component (i) in the particulate composition is >97% by weight and the proportion by weight of the sum total of components (ii) and (iii) in the particulate composition is <1% by weight.

15. The process of claim 14, wherein the polyethyleneimine in component (ii) has a molecular weight in the range of 500-2,000,000 Da.

16. The process of claim 15, wherein the polyvinylamine in component (ii) has a molecular weight in the range of 500-1,000,000 Da.

17. The process of claim 11, wherein the proportion by weight of component (i) in the composition is >98% by weight

18. The process of claim 17, wherein the proportion by weight of component (i) in the composition is >98.5% by weight.

19. The process of claim 11, wherein the proportion by weight of the sum total of components (ii) and (iii) in the composition is <0.5% by weight.

20. The process of claim 11, wherein the proportion by weight of the sum total of components (ii) and (iii) in the composition is <0.4% by weight.

21. The process of claim 11, wherein the proportion by weight of the sum total of components (ii) and (iii) in the composition is <0.3% by weight.

22. The process of claim 11, wherein the proportion by weight of the sum total of components (ii) and (iii) in the composition is <0.25% by weight.

23. A NOₓ reductant AUS 32 solution (diesel exhaust fluid) obtained by the process of claim 11.
